(19) United States
(12) Patent Application Publication
(10) Pub. No.: US 2018/0108218 A1
(43) Pub. Date: Apr. 19, 2018

(54) SYSTEM AND METHODS FOR ENHANCED COMPUTER GAME REWARDS

(71) Applicant: MasterCard International Incorporated, Purchase, NY (US)

(72) Inventors: Regan E. Harmon, O'Fallon, MO (US); Christopher T. Scholl, Hazelwood, MO (US); William Raymond Bowie, Lake St. Louis, MO (US)

(21) Appl. No.: 15/295,649

(22) Filed: Oct. 17, 2016

(51) Int. Cl. G07F 17/32; A63F 13/46; A63F 13/79

(52) U.S. Cl. CPC G07F 17/3251; G07F 17/3225; A63F 2300/558; A63F 13/46; A63F 13/79; G07F 17/3241

(57) ABSTRACT

A computer-implemented method enhancing computer game rewards is provided. The method is implemented using a game rewards computer device in communication with a memory. The method includes storing a reward account associated with a payment card that is associated with a cardholder. The reward account includes a total number of rewards points. The method also includes receiving from a game network an indication of a game-based achievement associated with the cardholder. The game-based achievement is based upon one or more actions performed by the cardholder in at least one computer-based game. The method further includes determining a number of rewards points associated with the game-based achievement and incrementing the total number of rewards points in reward account based upon the determined number of rewards points.

### BACKGROUND OF THE DISCLOSURE

The field of the disclosure relates generally to enhancing computer game rewards, and more specifically to methods and systems for enhancing computer game rewards based upon rewards points associated with a payment account.

Many gamers play video games on personal computers, console systems, such as Xbox® (Xbox is a registered trademark of Microsoft Corporation) or PlayStation® (PlayStation is a registered trademark of Sony Computer Entertainment Inc.), and mobile devices, such as tablets and smartphones. Many of these games are connected to or provided by a game network, such as the Xbox Live® (Xbox Live is a registered trademark of Microsoft Corporation), the PlayStation network, Steam® (Steam is a registered trademark of Valve Corp.), and BattleNet® (BattleNet is a registered trademark of Blizzard Entertainment, Inc.). Many gamers have accounts on the corresponding game network that tracks the gamer's activities, games owned, and achievements earned. Many computer games have achievements, where when the gamer performs a certain series of actions, such as completing a mission on hard mode, the gamer receives a virtual trophy or some other achievement. In many cases, the achievements are awarded by and stored by the game network. The achievements are associated with the gamer's account on the game network. The achievements may be displayed with the gamer's account for bragging rights.

### BRIEF DESCRIPTION OF THE DISCLOSURE

In one aspect, a computer-implemented method for enhancing computer game rewards is provided. The method is implemented using a game rewards computer device in communication with a memory. The method includes storing, at the game rewards computer device, a reward account associated with a payment card that is associated with a cardholder. The reward account includes a total number of rewards points. The method also includes receiving, at the game rewards computer device from a game network, an indication of a game-based achievement associated with the cardholder. The game-based achievement is based upon one or more actions performed by the cardholder in at least one computer-based game. The method further includes determining, at the game rewards computer device, a number of rewards points associated with the game-based achievement and incrementing the total number of rewards points in reward account based upon the determined number of rewards points.

In another aspect, a game rewards computer device used for enhancing computer game rewards is provided. The game rewards computer device includes a processor communicatively coupled to a memory device. The processor is programmed to store a reward account associated with a payment card that is associated with a cardholder. The reward account includes a total number of rewards points. The processor is also programmed to receive, from a game network, an indication of a game-based achievement associated with the cardholder. The game-based achievement is based upon one or more actions performed by the cardholder in at least one computer-based game. The processor is further programmed to determine a number of rewards points associated with the game-based achievement and increment the total number of rewards points in the reward account based upon the determined number of rewards points.

In yet another aspect, at least one non-transitory computer-readable storage media having computer-executable instructions embodied thereon is provided. When executed by a game rewards computer device having at least one processor coupled to at least one memory device, the computer-executable instructions cause the processor to store a reward account associated with a payment card that is associated with a cardholder. The reward account includes a total number of rewards points. The computer-executable instructions also cause the processor to receive, from a game network, an indication of a game-based achievement associated with the cardholder. The game-based achievement is based upon one or more actions performed by the cardholder in at least one computer-based game. The computer-executable instructions further cause the processor to determine a number of rewards points associated with the game-based achievement and increment the total number of rewards points in the reward account based upon the determined number of rewards points.

### BRIEF DESCRIPTION OF THE DRAWINGS

FIGS. 1-6 show example embodiments of the methods and systems described herein.

FIG. 1 is a schematic diagram illustrating an example multi-party payment processing system for enabling payment-by-card transactions.

FIG. 2 is a simplified block diagram of an example game rewards system used for enhancing computer game rewards based upon rewards points associated with a payment card.

FIG. 3 illustrates an example configuration of a client system shown in FIG. 2, in accordance with one embodiment of the present disclosure.

FIG. 4 illustrates an example configuration of a server system shown in FIG. 2, in accordance with one embodiment of the present disclosure.

FIG. 5 is a flow chart of a process for enhancing computer game rewards based upon rewards points associated with a payment card using the game rewards system shown in FIG. 2.

FIG. 6 is a diagram of components of one or more example computing devices that may be used in the game rewards system shown in FIG. 2.

### DETAILED DESCRIPTION OF THE DISCLOSURE

The following detailed description illustrates embodiments of the disclosure by way of example and not by way of limitation. The description clearly enables one skilled in the art to make and use the disclosure, and describes several embodiments, adaptations, variations, alternatives, and uses of the disclosure, including what is presently believed to be the best mode of carrying out the disclosure, of the system and methods to enhance computer game rewards based upon rewards points associated with a payment card.

In the example embodiment of the enhanced game rewards system, a game network is connected to a payment network and is linked to a payment card associated with the payment network. More specifically, the game network is connected to a payment processing computer device and a game rewards computer device. The payment processing computer device is part of the payment network. The game network may be directly or indirectly connected to the payment processing computer device via the game rewards computer device. The payment card is associated with a game-based rewards program through the game rewards computer device as described in greater detail below. The game network hosts or is associated with a plurality of computer games (also known as video games). For the purposes of this discussion, video games are electronic games that involve human interaction with a user interface to generate visual feedback on a video device for entertainment purposes and are considered distinct from electronic gambling. For the purposes of this invention, the player of the video game has not wagered money or virtual money to play the video. Furthermore, the results of the video game or the user earning an achievement are not dependent on an outside event, such as the results of a real-life sporting event.

When the gamer earns an achievement based upon actions in one or more computer games (also known as video games), a game network server transmits a message to a game rewards computer device, indicating that the gamer earned the achievement. The game rewards computer device determines how many points that achievement was worth and awards that many rewards points to the rewards program account associated with the gamer. The gamer can then use those rewards points to purchase goods and services, such as through a point redemption store. The game-based rewards are in addition to any rewards the gamer may earn through making everyday purchases with the payment card. In some embodiments, the gamer may receive a gift certificate for every predetermined number of rewards points earned.

In some embodiments, the rewards program is also associated with the payment card and may be managed by the payment processor. In these embodiments, the rewards program includes points earned by performing payment card transactions, which are processed by the payment processor in addition to rewards points earned through the game-based achievements.

In some embodiments, the rewards program includes a level based system, where the gamer will earn access to different products, services, and/or stores based upon his or her level in the cardholder rewards program, and that the level in the rewards program is determined based, at least in part on, a level achieved within the video game or level within the gaming account associated with a game network.

In some embodiments, a wallet application is stored on the game network that provides the connection between the game network and the game rewards computer device. In other embodiments, the game rewards computer device runs an API to read the achievements that the gamer has earned and updates based upon any changes. In some embodiments, the game rewards computer device is connected to multiple different game networks.

In some embodiments, the wallet application includes a user interface that is configured to display all of the achievements associated with all of the registered games. The user interface is also configured to display the rewards points earned for each game or series of games. The user interface is further configured to display rewards points earned from other regular purchases.

The methods and system described herein may be implemented using computer programming or engineering techniques including computer software, firmware, hardware, or any combination or subset. As disclosed above, at least one technical problem with prior systems is that there is a need for enhancing computer game rewards. The system and methods described herein address that technical problem. The technical effect of the systems and processes described herein is achieved by performing at least one of the following steps: (a) storing a reward account associated with a payment card that is associated with a cardholder, wherein the reward account includes a total number of rewards points, wherein the cardholder is able to exchange a plurality of rewards points from the reward account for goods and services, and wherein the player reward account is associated with a game account based upon a game network; (b) determining a level for the reward account based, at least in part on, the total number of rewards points; (c) allowing the cardholder access to one or more additional services based upon the level; (d) receiving an indication of a game-based achievement associated with the cardholder from a game network, wherein the game-based achievement is based upon one or more actions performed by the cardholder in at least one computer-based game, wherein the computer-based game is associated with the game network, and wherein the computer-based game requires skill based interactions by the cardholder as a part of playing the game, and wherein the game-based achievement is based upon at least one of achieving a predetermined level in a computer-based game, earning a predetermined number of points in a computer-based game, performing a predetermined series of actions in a computer-based game, completing a computer-based game at a predetermined difficulty level, earning a predetermined number of game-based achievements, earning a predetermining level associated with a game account on the game network, and earning a predetermining number of points associated with a game account on the game network; (e) associating a wallet application with the game network, wherein the wallet application is configured to display one or more game-based achievements and the rewards points associated with each of the one or more game-based achievements; (f) determining a number of rewards points associated with the game-based achievement; (g) incrementing the total number of rewards points in the reward account based upon the determined number of rewards points; (h) receiving an indication of a payment transaction conducted by the cardholder using the payment card associated with the reward account; and (i) incrementing the total number of rewards points based upon the payment transaction. The resulting technical effect is providing real-world rewards for computer game achievements through a rewards program.

As used herein, the terms “transaction card,” “financial transaction card,” and “payment card” refer to any suitable transaction card, such as a credit card, a debit card, a prepaid card, a charge card, a membership card, a promotional card, a frequent flyer card, an identification card, a gift card, and/or any other device that may hold payment account information, such as mobile phones, Smartphones, personal digital assistants (PDAs), key fobs, and/or computers. Each type of transaction card can be used as a method of payment for performing a transaction.

In one embodiment, a computer program is provided, and the program is embodied on a computer-readable medium. In an example embodiment, the system is executed on a single computer system, without requiring a connection to a server computer. In a further example embodiment, the system is being run in a Windows® environment (Windows is a registered trademark of Microsoft Corporation, Redmond, Wash.). In yet another embodiment, the system is run on a mainframe environment and a UNIX® server environment (UNIX is a registered trademark of X/Open Company Limited located in Reading, Berkshire, United Kingdom). In a further embodiment, the system is run on an iOS® environment (iOS is a registered trademark of Cisco Systems, Inc. located in San Jose, Calif.). In yet a further embodiment, the system is run on a Mac OS® environment (Mac OS is a registered trademark of Apple Inc. located in Cupertino, Calif.). The application is flexible and designed to run in various different environments without compromising any major functionality. In some embodiments, the system includes multiple components distributed among a plurality of computing devices. One or more components are in the form of computer-executable instructions embodied in a computer-readable medium. The systems and processes are not limited to the specific embodiments described herein. In addition, components of each system and each process can be practiced independently and separately from other components and processes described herein. Each component and process can also be used in combination with other assembly packages and processes.

In one embodiment, a computer program is provided, and the program is embodied on a computer-readable medium and utilizes a Structured Query Language (SQL) with a client user interface front-end for administration and a web interface for standard user input and reports. In another embodiment, the system is web enabled and is run on a business entity intranet. In yet another embodiment, the system is fully accessed by individuals having an authorized access outside the firewall of the business-entity through the Internet. In a further embodiment, the system is being run in a Windows® environment (Windows is a registered trademark of Microsoft Corporation, Redmond, Wash.). The application is flexible and designed to run in various different environments without compromising any major functionality.

As used herein, an element or step recited in the singular and preceded with the word “a” or “an” should be understood as not excluding plural elements or steps, unless such exclusion is explicitly recited. Furthermore, references to “example embodiment” or “one embodiment” of the present disclosure are not intended to be interpreted as excluding the existence of additional embodiments that also incorporate the recited features.

As used herein, the term “database” may refer to either a body of data, a relational database management system (RDBMS), or to both. A database may include any collection of data including hierarchical databases, relational databases, flat file databases, object-relational databases, object oriented databases, and any other structured collection of records or data that is stored in a computer system. The above examples are for example only, and thus are not intended to limit in any way the definition and/or meaning of the term database. Examples of RDBMS's include, but are not limited to including, Oracle® Database, MySQL, IBM® DB2, Microsoft® SQL Server, Sybase®, and PostgreSQL. However, any database may be used that enables the system and methods described herein. (Oracle is a registered trademark of Oracle Corporation, Redwood Shores, Calif.; IBM is a registered trademark of International Business Machines Corporation, Armonk, N.Y.; Microsoft is a registered trademark of Microsoft Corporation, Redmond, Wash.; and Sybase is a registered trademark of Sybase, Dublin, Calif.)

The term processor, as used herein, may refer to central processing units, microprocessors, microcontrollers, reduced instruction set circuits (RISC), application specific integrated circuits (ASIC), logic circuits, and any other circuit or processor capable of executing the functions described herein.

As used herein, the terms “software” and “firmware” are interchangeable, and include any computer program stored in memory for execution by a processor, including RAM memory, ROM memory, EPROM memory, EEPROM memory, and non-volatile RAM (NVRAM) memory. The above memory types are for example only, and are thus not limiting as to the types of memory usable for storage of a computer program.

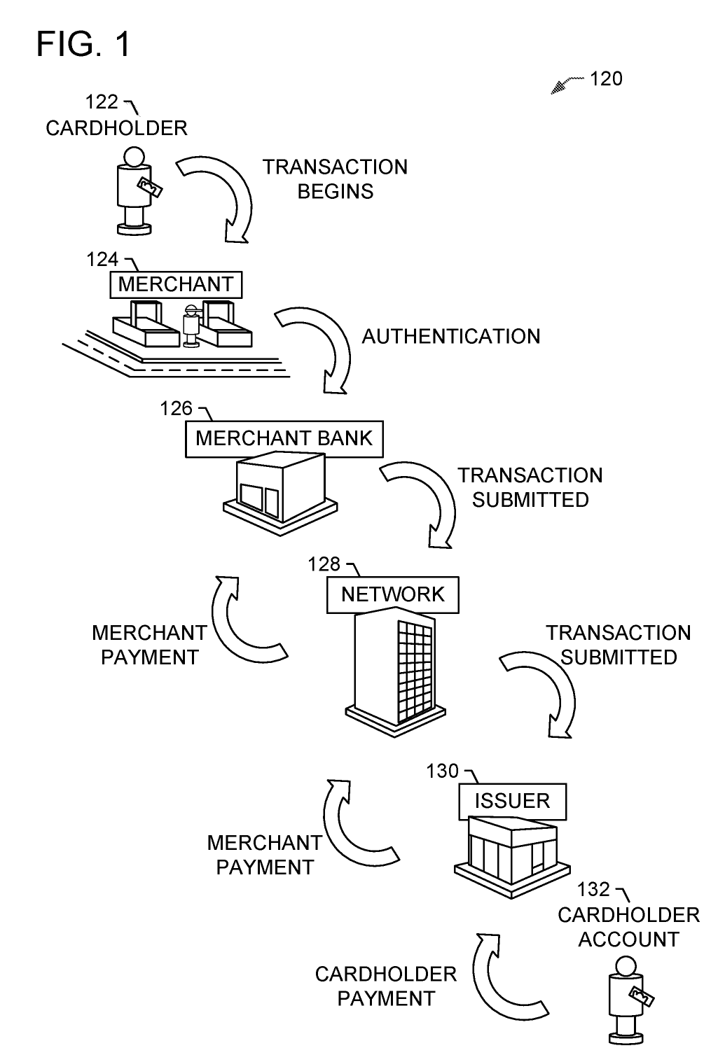

FIG. 1 is a schematic diagram illustrating an example multi-party payment processing system 120 for enabling payment-by-card transactions. Embodiments described herein may relate to a transaction card system, such as a credit card payment system using the MasterCard® interchange network. The MasterCard® interchange network is a set of proprietary communications standards promulgated by MasterCard International Incorporated® for the exchange of financial transaction data and the settlement of funds between financial institutions that are members of MasterCard International Incorporated®. (MasterCard is a registered trademark of MasterCard International Incorporated located in Purchase, N.Y.).

In a typical transaction card system, a financial institution called the “issuer” issues a transaction card or electronic payments account identifier, such as a credit card, to a consumer or cardholder 122, who uses the transaction card to tender payment for a purchase from a merchant 124. To accept payment with the transaction card, merchant 124 must normally establish an account with a financial institution that is part of the financial payment system. This financial institution is usually called the “merchant bank,” the “acquiring bank,” or the “acquirer.” When cardholder 122 tenders payment for a purchase with a transaction card, merchant 124 requests authorization from a merchant bank 126 for the amount of the purchase. The request may be performed over the telephone, but is usually performed through the use of a point-of-sale terminal, which reads cardholder's 122 account information from a magnetic stripe, a chip, or embossed characters on the transaction card and communicates electronically with the transaction processing computers of merchant bank 126. Alternatively, merchant bank 126 may authorize a third party to perform transaction processing on its behalf. In this case, the point-of-sale terminal will be configured to communicate with the third party. Such a third party is usually called a “merchant processor,” an “acquiring processor,” or a “third party processor.”

Using an interchange network 128, computers of merchant bank 126 or merchant processor will communicate with computers of an issuer bank 130 to determine whether cardholder's 122 account 132 is in good standing and whether the purchase is covered by cardholder's 122 available credit line. Based on these determinations, the request for authorization will be declined or accepted. If the request is accepted, an authorization code is issued to merchant 124.

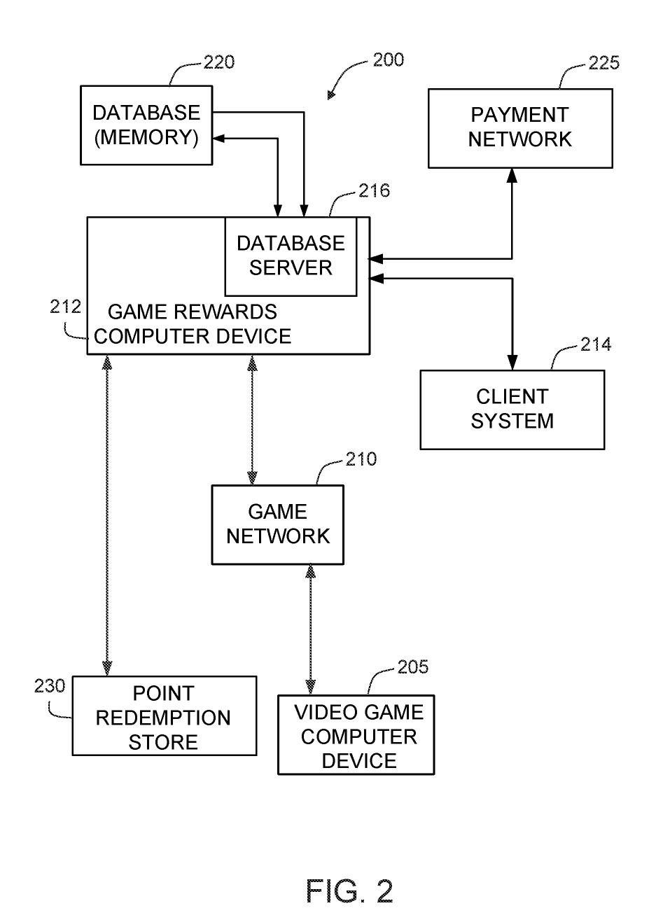

When a request for authorization is accepted, the available credit line of cardholder's 122 account 132 is decreased. Normally, a charge for a payment card transaction is not posted immediately to cardholder's 122 account 132 because bankcard associations, such as MasterCard International Incorporated®, have promulgated rules that do not allow merchant 124 to charge, or “capture,” a transaction until goods are shipped or services are delivered. However, with respect to at least some debit card transactions, a charge may be posted at the time of the transaction. When merchant 124 ships or delivers the goods or services, merchant 124 captures the transaction by, for example, appropriate data entry procedures on the point-of-sale terminal. This may include bundling of approved transactions daily for standard retail purchases. If cardholder 122 cancels a transaction before it is captured, a “void” is generated. If cardholder 122 returns goods after the transaction has been captured, a “credit” is generated. Interchange network 128 and/or issuer bank 130 stores the transaction card information, such as a category of merchant, a merchant identifier, a location where the transaction was completed, amount of purchase, date and time of transaction, in a database 220 (shown in FIG. 2).

After a purchase has been made, a clearing process occurs to transfer additional transaction data related to the purchase among the parties to the transaction, such as merchant bank 126, interchange network 128, and issuer bank 130. More specifically, during and/or after the clearing process, additional data, such as a time of purchase, a merchant name, a type of merchant, purchase information, cardholder account information, a type of transaction, itinerary information, information regarding the purchased item and/or service, and/or other suitable information, is associated with a transaction and transmitted between parties to the transaction as transaction data, and may be stored by any of the parties to the transaction. In the example embodiment, when cardholder 122 purchases travel, such as airfare, a hotel stay, and/or a rental car, at least partial itinerary information is transmitted during the clearance process as transaction data. When interchange network 128 receives the itinerary information, interchange network 128 routes the itinerary information to database 220.

For debit card transactions, when a request for a personal identification number (PIN) authorization is approved by the issuer, cardholder's account 132 is decreased. Normally, a charge is posted immediately to cardholder's account 132. The payment card association then transmits the approval to the acquiring processor for distribution of goods/services or information, or cash in the case of an automated teller machine (ATM).

After a transaction is authorized and cleared, the transaction is settled among merchant 124, merchant bank 126, and issuer bank 130. Settlement refers to the transfer of financial data or funds among merchant's 124 account, merchant bank 126, and issuer bank 130 related to the transaction. Usually, transactions are captured and accumulated into a “batch,” which is settled as a group. More specifically, a transaction is typically settled between issuer bank 130 and interchange network 128, and then between interchange network 128 and merchant bank 126, and then between merchant bank 126 and merchant 124.

In some embodiments, cardholder 122 registers one or more payment cards with a digital wallet. Having done this, cardholder 122 can interact with a participating online merchant 124. At the check-out stage, online merchant 124 displays a button on the merchant website which cardholder 122 can click on in order to make a payment using the cardholder's digital wallet. Online merchant 124 then redirects the user to a “switch” operated by interchange network 128. Using a cookie located on the cardholder's computer, the “switch” is able to determine which wallet-hosting server hosts a wallet associated with cardholder 122. The switch then establishes a connection between the cardholder's computer and the appropriate wallet-hosting system, which presents cardholder 122 with a sign-in page (e.g., as a pop-up window), where there is an authentication process (e.g., entry of a pre-agreed password). This log-in process may use the same login credentials (e.g., password) which the user also uses to obtain access to other online banking activities.

The wallet-hosting system then securely transfers the cardholder's payment information to the online merchant's domain. The merchant's domain submits the cardholder's payment information to acquiring bank 126 for a separate authorization process in which the acquiring domain communicates with the issuing bank 130 to ask the bank to authorize the transaction. Thus, cardholder 122 is not required to enter their card details (except at the stage of initially registering with the wallet-hosting system), and the online transaction process is streamlined with only a single redirection, and consistent branding for the entire payment process, irrespective of the online merchant 124.

FIG. 2 is a simplified block diagram of an example game rewards system 200 used for enhancing computer game rewards based upon rewards points associated with a payment card. In the example embodiment, game rewards system 200 includes a game rewards computer device 212 configured to enhance computer game rewards based upon rewards points associated with a payment card. As described below in more detail, game rewards computer device 212 is configured to store a reward account associated with a payment card that is associated with a cardholder 122 (shown in FIG. 1) and receive, from a game network, an indication of a game-based achievement associated with cardholder 122. The game-based achievement is based upon one or more actions performed by cardholder 122 in at least one computer-based game. Game rewards computer device 212 also determines a number of rewards points associated with the game-based achievement and increments the total number of rewards points in the reward account based upon the determined number of rewards points.

In the example embodiment, video game computer devices 205 are computers that include a web browser or a software application to enable video game computer devices 205 to access a game network 210 using the Internet. Video game computer devices 205 are configured to allow users to play computer games also known as video games. In the example embodiment, video game computer devices 205 connects to game network 210 prior to, or during, play of one or more computer games. More specifically, video game computer devices 205 are communicatively coupled to the Internet through many interfaces including, but not limited to, at least one of a network, such as a local area network (LAN), a wide area network (WAN), or an integrated services digital network (ISDN), a dial-up-connection, a digital subscriber line (DSL), a cellular phone connection, and a cable modem. Video game computer devices 205 can be any device capable of accessing the Internet and executing a computer game including, but not limited to, a desktop computer, a laptop computer, a personal digital assistant (PDA), a cellular phone, a smartphone, a tablet, a phablet, a gaming console, or other web-based connectable equipment. In the example embodiment, cardholder 122 uses a video game computer device 205 to access game network 210 while playing one or more computer games.

In the example embodiment, game network 210 is a network of computer devices configured to provide one or more games and/or game experiences to users playing computer games through video game computer devices 205. In the example embodiment, game network 210 is a networked plurality of server computer devices. In some embodiments, game network 210 is configured to provide communication and interaction with other video game computer devices 205 during play of the computer game. In some embodiments, such as in the case of a massive multiple player online role-playing game (MMORPG), game network 210 is provides an integral part of the computer game that allows the player to play the game. In some further embodiments, game network 210 hosts the computer game and video game computer devices 205 connect to the game via a client application, such a web browser. In some embodiments, game network 210 includes an online store that sells computer games for users to download onto video game computer devices 205. In the example environment, each user of game network 210 has their own game account. The game account may include the games that the associated user owns, information about what actions that the user has taken in the games, any achievements or awards that the user has earned through playing the games, or any collectable tokens or virtual cards that the user has collected through accessing games while logged into game network 210. In some embodiments, game network 210 is capable of streaming audio and video content, such as movies, TV shows, and music to video game computer devices 205.

In the example embodiment, client systems 214 are computers that include a web browser or a software application to enable client systems 214 to access game rewards computer device 212 using the Internet. More specifically, client systems 214 are communicatively coupled to the Internet through many interfaces including, but not limited to, at least one of a network, such as a local area network (LAN), a wide area network (WAN), or an integrated services digital network (ISDN), a dial-up-connection, a digital subscriber line (DSL), a cellular phone connection, and a cable modem. Client systems 214 can be any device capable of accessing the Internet including, but not limited to, a desktop computer, a laptop computer, a personal digital assistant (PDA), a cellular phone, a smartphone, a tablet, a phablet, or other web-based connectable equipment. In the example embodiment, cardholder 122 uses a client system 214 to access the cardholder's reward account.

A database server 216 is communicatively coupled to a database 220 that stores data. In one embodiment, database 220 includes reward accounts, gamer achievements, game networks 210, and reward level information. In the example embodiment, database 220 is stored remotely from game rewards computer device 212. In some embodiments, database 220 is decentralized. In the example embodiment, a person can access database 220 via client systems 214 by logging onto game rewards computer device 212, as described herein.

In the example embodiment, game rewards computer device 212 is communicatively coupled with payment network 225. Payment network 225 represents one or more parts of payment processing system 120 (shown in FIG. 1). In the example embodiment, game rewards computer device 212 is in communication with one or more computer devices associated with interchange network 128. In other embodiments, game rewards computer device 212 is in communication with one or more computer devices associated with merchant bank 126 (shown in FIG. 1). In some embodiments, game rewards computer device 212 may be associated with, or is part of payment processing system 120, or in communication with payment processing system 120. In other embodiments, game rewards computer device 212 is associated with a third party and is in communication with payment processing system 120. In some embodiments, game rewards computer device 212 may be associated with, or be part of merchant bank 126, interchange network 128, and issuer bank 130. In addition, game rewards computer device 212 is communicatively coupled with one or more game networks 210. In the example embodiment, game rewards computer device 212 is in communication with game networks 210 via Application Programming Interface (API) calls. Through the API call, game networks 210 may transmit information to and receive information from game rewards computer device 212. In some embodiments, game rewards computer device 212 is a part of game network 210.

In some embodiments, game rewards computer device 212 may be associated with the financial transaction interchange network 128 shown in FIG. 1 and may be referred to as an interchange computer system. Game rewards computer device 212 may be used for processing transaction data and analyzing for fraudulent transactions. In addition, at least one of client systems 214 may include a computer system associated with an issuer 130 of a transaction card. Accordingly, game rewards computer device 212 and client systems 214 may be utilized to process transaction data relating to purchases a cardholder 122 makes utilizing a transaction card processed by interchange network 128 and issued by the associated issuer 130. At least one client system 214 may be associated with a user or a cardholder 122 seeking to register, access information, or process a transaction with at least one of interchange network 128, issuer 130, or merchant 124. In addition, client systems 214 may include point-of-sale (POS) devices associated with merchant 124 and used for processing payment transactions.

In the example embodiment, game rewards computer device 212 is in communication with a point redemption store 230. In the example embodiment, point redemption store 230 is an online or ecommerce store that allows a cardholder to purchase goods and/or services using reward points that have been earned and stored by game rewards computer device 212. Examples of goods and services include, but are not limited to, branded clothing and items, additional computer games, computer game expansions, specialty character skins, in-game items, forum badges, and gift cards.

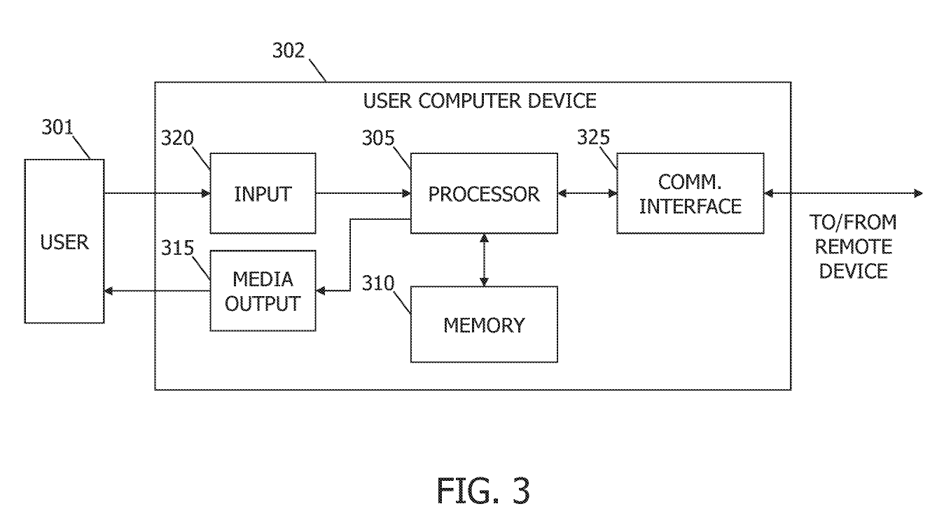

FIG. 3 illustrates an example configuration of a client system 214 shown in FIG. 2, in accordance with one embodiment of the present disclosure. User computer device 302 is operated by a user 301. User computer device 302 may include, but is not limited to, client systems 214 and video game computer devices 205 (shown in FIG. 2). User computer device 302 includes a processor 305 for executing instructions. In some embodiments, executable instructions are stored in a memory area 310. Processor 305 may include one or more processing units (e.g., in a multi-core configuration). Memory area 310 is any device allowing information such as executable instructions and/or transaction data to be stored and retrieved. Memory area 310 may include one or more computer-readable media.

User computer device 302 also includes at least one media output component 315 for presenting information to user 301. Media output component 315 is any component capable of conveying information to user 301. In some embodiments, media output component 315 includes an output adapter (not shown) such as a video adapter and/or an audio adapter. An output adapter is operatively coupled to processor 305 and operatively coupleable to an output device such as a display device (e.g., a cathode ray tube (CRT), liquid crystal display (LCD), light emitting diode (LED) display, or “electronic ink” display) or an audio output device (e.g., a speaker or headphones). In some embodiments, media output component 315 is configured to present a graphical user interface (e.g., a web browser and/or a client application) to user 301. A graphical user interface may include, for example, an online store interface for viewing and/or purchasing items, and/or a wallet application for managing payment information. In some embodiments, user computer device 302 includes an input device 320 for receiving input from user 301. User 301 may use input device 320 to, without limitation, select and/or enter one or more items to purchase and/or a purchase request, or to access credential information, and/or payment information. Input device 320 may include, for example, a keyboard, a pointing device, a mouse, a stylus, a touch sensitive panel (e.g., a touch pad or a touch screen), a gyroscope, an accelerometer, a position detector, a biometric input device, and/or an audio input device. A single component such as a touch screen may function as both an output device of media output component 315 and input device 320.

User computer device 302 may also include a communication interface 325, communicatively coupled to a remote device such as game rewards computer device 212 and game network 210 (both shown in FIG. 2). Communication interface 325 may include, for example, a wired or wireless network adapter and/or a wireless data transceiver for use with a mobile telecommunications network.

Stored in memory area 310 are, for example, computer-readable instructions for providing a user interface to user 301 via media output component 315 and, optionally, receiving and processing input from input device 320. The user interface may include, among other possibilities, a web browser and/or a client application. Web browsers enable users, such as user 301, to display and interact with media and other information typically embedded on a web page or a website from game rewards computer device 212. A client application allows user 301 to interact with, for example, game rewards computer device 212 and game network 210. For example, instructions may be stored by a cloud service and the output of the execution of the instructions sent to the media output component 315.

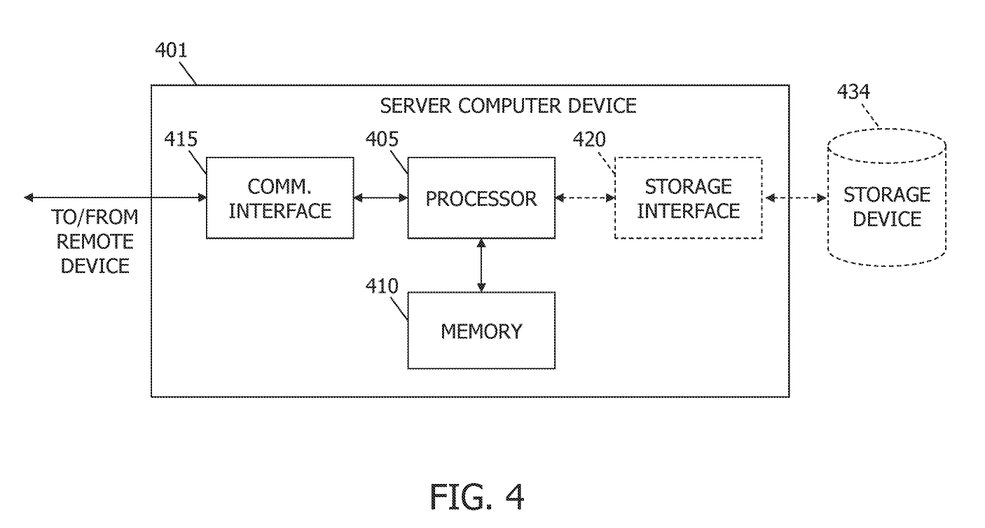

FIG. 4 illustrates an example configuration of a server system shown in FIG. 2, in accordance with one embodiment of the present disclosure. Server computer device 401 may include, but is not limited to, database server 216, one or more computer devices in game network 210, point redemption store 230, and game rewards computer device 212 (all shown in FIG. 2). Server computer device 401 also includes a processor 405 for executing instructions. Instructions may be stored in a memory area 410. Processor 405 may include one or more processing units (e.g., in a multi-core configuration).

Processor 405 is operatively coupled to a communication interface 415 such that server computer device 401 is capable of communicating with a remote device such as another server computer device 401, client systems 214, point redemption store 230, game network 210, payment network 225 (shown in FIG. 2), or game rewards computer device 212. For example, communication interface 415 may receive requests from client systems 214 via the Internet.

Processor 405 may also be operatively coupled to a storage device 434. Storage device 434 is any computer-operated hardware suitable for storing and/or retrieving data, such as, but not limited to, data associated with database 220 (shown in FIG. 2). In some embodiments, storage device 434 is integrated in server computer device 401. For example, server computer device 401 may include one or more hard disk drives as storage device 434. In other embodiments, storage device 434 is external to server computer device 401 and may be accessed by a plurality of server computer devices 401. For example, storage device 434 may include a storage area network (SAN), a network attached storage (NAS) system, and/or multiple storage units such as hard disks and/or solid state disks in a redundant array of inexpensive disks (RAID) configuration.

In some embodiments, processor 405 is operatively coupled to storage device 434 via a storage interface 420. Storage interface 420 is any component capable of providing processor 405 with access to storage device 434. Storage interface 420 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 405 with access to storage device 434.

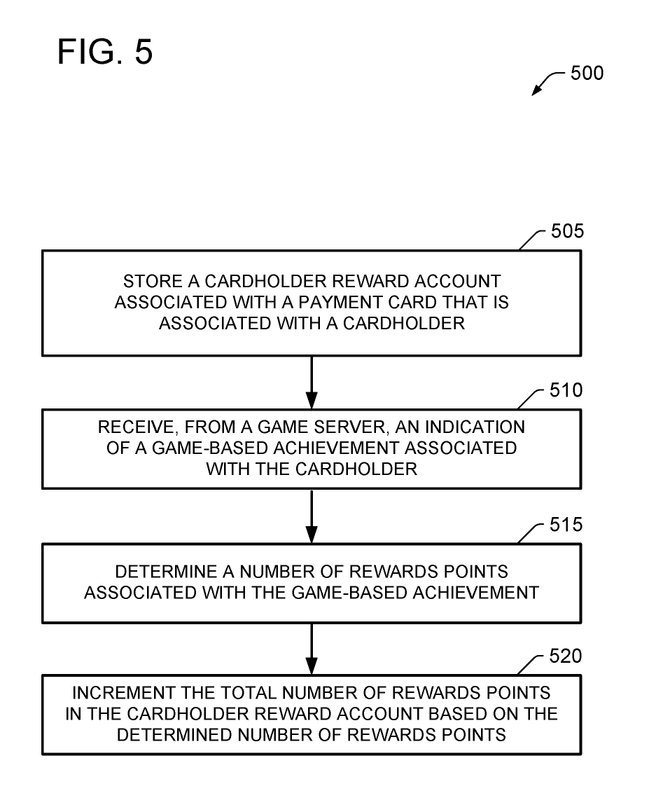

Processor 405 executes computer-executable instructions for implementing aspects of the disclosure. In some embodiments, processor 405 is transformed into a special purpose microprocessor by executing computer-executable instructions or by otherwise being programmed. For example, processor 405 is programmed with the instructions such as are illustrated in FIG. 5.

FIG. 5 is a flow chart of a process 500 enhancing computer game rewards based upon rewards points associated with a payment card using game rewards system 200 shown in FIG. 2. In the example embodiment, process 500 is performed by game rewards computer device 212 (shown in FIG. 2).

In the example embodiment, game rewards computer device 212 stores 505 a reward account associated with a payment card that is associated with cardholder 122 (shown in FIG. 1). In the example embodiment, the reward account is based upon a loyalty program associated with at least one of merchant 124, issuing bank 130, and interchange network 128 (all shown in FIG. 1). The reward account accumulates rewards points based upon the transactions of cardholder 122. Cardholder 122 is then able to exchange rewards points for goods and/or services, such as through point redemption store 230 (shown in FIG. 2). In some embodiments, cardholder 122 may receive a gift certificate for every predetermined number of rewards points earned. In the example embodiment when cardholder 122 conducts a transaction with the payment card corresponding to the reward account, cardholder 122 earns one or more rewards points based, at least in part, on the transaction price, the associated merchant 124, and the goods and/or services purchased. In some embodiments, cardholder 122 is provided services based upon the number of rewards points that cardholder 122 has accumulated.

In the example embodiment, reward account includes a plurality of levels. Each level is awarded when cardholder 122 earns a predetermined number of reward points. In some embodiments, earning a new level unlocks new goods and/or services that cardholder 122 has access to. For example, earning a new level may provide cardholder 122 with access to additional items that may be purchased through point redemption store 230. Earning a new level may also provide cardholder 122 with a free computer game or in-game items for a popular computer game. In some embodiments, levels are based upon lifetime reward points earned. In other embodiments, levels are based upon earning a predetermined number of rewards points within a predetermined period of time.

In the example embodiment, reward account is linked to one or more game accounts associated with cardholder 122. In the example embodiment, each game account is associated with a different game network 210. Each game network 210 provides access to computer games (also known as video games) and a video game social community. For the purposes of this discussion, video games are electronic games that involve human interaction with a user interface to generate visual feedback on a video device for entertainment purposes and are considered distinct from electronic gambling. Cardholder 122 uses video game computer device 205 to play games provided by game network 210. In the example embodiment, game network 210 tracks cardholder's interactions while playing different games.

Game network 210 awards an achievement to cardholder 122 based upon cardholder's actions while logged into game network 210. Achievements may also be known as trophies, badges, awards, stamps, medals, or challenges. In the example embodiment, each achievement may only be earned once; the cardholder cannot perform the same actions a second time to earn the achievement again. However, in some embodiments, achievements are repeatable. Some examples of achievements awarded by game network 210 include, but are not limited to, achieving a predetermined level in a computer-based game, earning a predetermined number of points in a computer-based game, performing a predetermined series of actions in a computer-based game, completing all or a predetermined portion of a computer-based game at a predetermined difficulty level, earning a predetermined number of game-based achievements, earning a predetermining level associated with a game account on game network 210, and earning a predetermining number of points associated with a game account on game network 210.

In the example embodiment, game rewards computer device 212 receives 510, from game network 210, an indication that cardholder 122 has earned an achievement. In some embodiments, game network 210 transmits a message to game rewards computer device 212 in real-time, when cardholder 122 earns the achievement. In other embodiments, game rewards computer device 212 regularly polls game network 210 about cardholder 122 and any achievements that cardholder 122 may have earned. For example, game rewards computer device 212 may use an API to retrieve information about cardholder's gaming account from game network 210. Game rewards computer device 212 then compares the information with the last time that it retrieved the data for changes, i.e., new achievements earned.

Game rewards computer device 212 determines 515 a number of reward points associated with the achievement. In the example embodiment, database 220 (shown in FIG. 2) stores a listing of achievements that could be earned through game network 210. Database 220 also stores a number of rewards points that each achievement is worth. In some embodiments, database 220 stores different amounts of reward points for different achievements. These amounts may be based upon difficulty to achieve, rarity of the achievement, time required to complete, and promotional considerations. The amounts of reward points that each achievement is worth may change over time, for example, during a promotional period, such as right after the release of a new computer game, achievements associated with that computer game may be worth twice as much as normal. In some embodiments, each different game network 210 includes different achievements, potentially based upon the different computer games associated with each game network 210.

Game rewards computer device 212 increments 520 the total number of rewards points in the reward account based upon the determined number of reward points for earning the achievement. In some embodiments, game rewards computer device 212 transmits a message to cardholder 122 to congratulate cardholder 122 on earning the achievement and the associated reward points. In some embodiments, the message may be sent to a client system 214 (shown in FIG. 2) associated with cardholder 122, such as via an MMS text message or email. In other embodiments, game rewards computer device 212 instructs video game computer device 205 to display the message, such as through a pop-up message.

In some embodiments, reward account is connected to game network 210 through a wallet application on game network 210. The wallet application stores payment card information and allows cardholder 122 to purchase goods and/or services from game network 210. In these embodiments, the wallet application also displays information about reward account, such as, but not limited to, achievements earned, current total rewards points, current level in reward account, and a current ranking of cardholder 122 in relation to other cardholders enrolled in similar reward accounts on game network 210. In some embodiments, the wallet application includes a user interface that is configured to display all of the achievements associated with all of the registered games. The user interface is also configured to display the rewards points earned for each game or series of games. The user interface is further configured to display rewards points earned from other regular purchases.

In some embodiments, when cardholder 122 initially links reward account to the cardholder's game account on game network 210, cardholder 122 earns reward points based upon at least one of the cardholder's game account's level, number of points earned in game account, and one or more past achievements earned.

In some embodiments, game rewards computer device 212 receives registration information from a cardholder 122. The registration information includes information, such as, cardholder name, payment account number, cardholder address, game network account information, games played, and cardholder preferences. Game rewards computer device 212 generates the cardholder reward account for the cardholder, including a reward account number. Game rewards computer device 212 stores 505 the information for the cardholder reward account in database 220. Game rewards computer device 212 also stores the game-based achievements that cardholder 122 has earned and received rewards for.

In some embodiments, game rewards computer device 212 transmits a request to game network 210 using the game network account information to determine the achievements that cardholder 122 has already earned. In some embodiments, game rewards computer device 212 receives the indication of each achievement associated with cardholder 122. In these embodiments, game network 210 receives the request including game network account information for cardholder's game network account. Game network 210 submits a query to a database 220 associated with game network 210. In some embodiments, game network 210 submits a query including a game network account name to database 220 to determine which account is associated with the account name. Game network 210 then transmits a query to database 220 to retrieve all of the achievements associated with that game network account. In other embodiments, game rewards computer device 212 uses an API to submit a query to database 220 associated with game network 210, where the query includes a game network account name associated with cardholder 122. The API retrieves the list of achievements earned by cardholder 122.

During registration, game rewards computer device 212 adds the received list of achievements to the list of completed achievements in the cardholder reward account. In some embodiments, game rewards computer device 212 determines 515 a number of rewards points associated with some or all of the game-based achievements on the received list as a part of registration. In other embodiments, cardholder 122 may only receive rewards points for achievements earned after registration is complete.

In some embodiments, game network 210 stores rewards account information and transmits a message to game rewards computer device 212 every time that cardholder 122 earns an achievement in real-time. In some further embodiments, game network 210 transmits the earned achievements over a period of time. In other embodiments, game network 210 is unaware of cardholder's rewards account and game rewards computer device 212 transmits queries to game network 210 or the database 220 associated with game network 210 to determine if cardholder 122 has earned any new achievements. In some embodiments, game rewards computer device 212 receives 510 an indication of the achievements earned in a period of time. In other embodiments, game rewards computer device 122 receives a list of all of the achievements earned. In these embodiments, game rewards computer device 122 compares the received list to the stored list, in the game rewards account, of previously earned achievements to determine if there are any newly earned achievements. In the example embodiment, each achievement includes a unique identifier to uniquely identify the game-based achievement. In these embodiments, database 220 associated with the rewards program is indexed by the unique identifiers. The indication of the game-based achievement includes the unique identifier.

When game rewards computer device 212 receives 510 an indication of a newly earned game-based achievement, game rewards computer device 212 determines 515 a number of rewards points associated with a game-based achievement, game rewards computer device 212 transmits a query including an achievement identifier to a database 220 associated with the game rewards program. Database 220 includes a listing of each potential achievement that a cardholder 122 may earn and the reward points associated with earning that achievement. Database 220 responds with the number of rewards points for the requested achievement.

In some embodiments, game rewards computer device 212 may display a list of the achievements and the associated reward points for cardholder to view. This displayed list may be a partial list. The list may be configured to encourage cardholder to complete certain achievements.

In some embodiments, the indication of a game-based achievement includes a unique identifier for the game-based achievement. In these embodiments, game rewards computer device 212 generates a database query including the unique identifier. Game rewards computer device 212 transmits the database query to a database 220. Game rewards computer device 212 receives, from database 220, results of the query. Game rewards computer device 212 determines 515 a number of rewards points based on the results of the query.

In some further embodiments, game rewards computer device 212 stores 505, in database 220, a plurality of unique identifiers in the cardholder reward account. The plurality of unique identifiers represents the achievements already earned by cardholder 122. Game rewards computer device 212 generates a database query including the received unique identifier to compare to the plurality of unique identifiers. Game rewards computer device 212 transmits the database query to database 220. Game rewards computer device 212 receives, from database 220, results of the query. Game rewards computer device 212 determines that the received unique identifier is associated with a newly earned achievement if the received unique identifier is not contained in the plurality of unique identifiers based on the received query results.

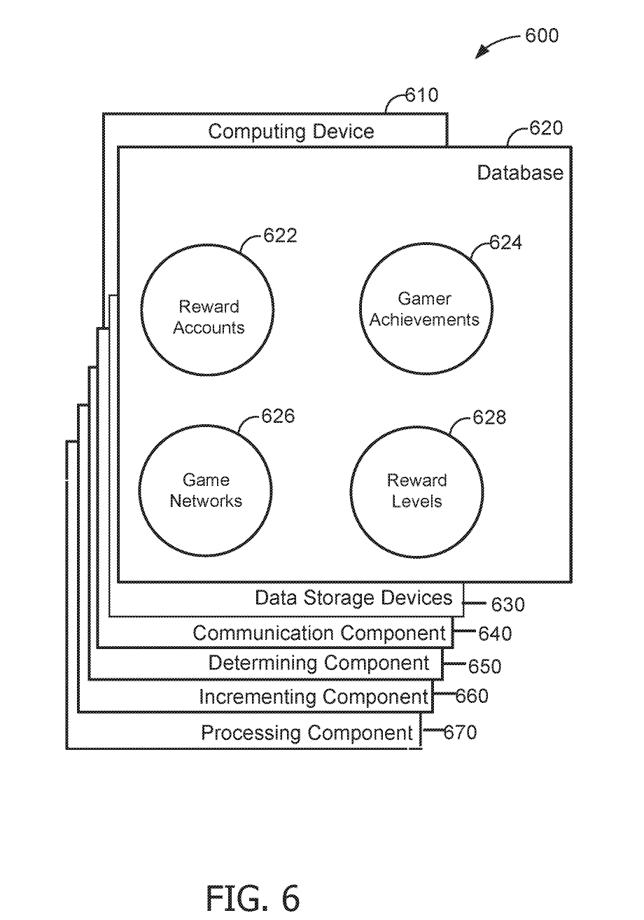

FIG. 6 is a diagram 600 of components of one or more example computing devices that may be used in game rewards system 200 shown in FIG. 2. In some embodiments, computing device 610 is similar to game rewards computer device 212 (shown in FIG. 2). Database 620 may be coupled with several separate components within computing device 610, which perform specific tasks. In this embodiment, database 620 includes reward accounts 622, gamer achievements 624, game networks 626, and reward levels 628. In some embodiments, database 620 is similar to database 220 (shown in FIG. 2).

Computing device 610 includes database 620, as well as data storage devices 630. Computing device 610 also includes a communication component 640 for receiving 510 an indication of an achievement (shown in FIG. 5). Computing device 610 also includes a determining component 650 for determining 515 a number of rewards points (shown in FIG. 5). Computing device 610 further includes an incrementing component 660 for incrementing 520 the total number of reward points (shown in FIG. 5). A processing component 670 assists with execution of computer-executable instructions associated with the system.

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

While the disclosure has been described in terms of various specific embodiments, those skilled in the art will recognize that the disclosure can be practiced with modification within the spirit and scope of the claims.

As used herein, the term “non-transitory computer-readable media” is intended to be representative of any tangible computer-based device implemented in any method or technology for short-term and long-term storage of information, such as, computer-readable instructions, data structures, program modules and sub-modules, or other data in any device. Therefore, the methods described herein may be encoded as executable instructions embodied in a tangible, non-transitory, computer readable medium, including, without limitation, a storage device and/or a memory device. Such instructions, when executed by a processor, cause the processor to perform at least a portion of the methods described herein. Moreover, as used herein, the term “non-transitory computer-readable media” includes all tangible, computer-readable media, including, without limitation, non-transitory computer storage devices, including, without limitation, volatile and nonvolatile media, and removable and non-removable media such as a firmware, physical and virtual storage, CD-ROMs, DVDs, and any other digital source such as a network or the Internet, as well as yet to be developed digital means, with the sole exception being a transitory, propagating signal.

This written description uses examples to disclose the embodiments, including the best mode, and also to enable any person skilled in the art to practice the embodiments, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial locational differences from the literal languages of the claims.

What is claimed is:

1. A computer-based method for enhancing computer game rewards, said method implemented using a game rewards computer device in communication with a memory, said method comprising:
storing, at the game rewards computer device, a reward account associated with a payment card that is associated with a cardholder, wherein the reward account includes a total number of rewards points;
receiving, at the game rewards computer device from a game network, an indication of a game-based achievement associated with the cardholder, wherein the game-based achievement is based upon one or more actions performed by the cardholder in at least one computer-based game;
determining, at the game rewards computer device, a number of rewards points associated with the game-based achievement; and
incrementing the total number of rewards points in reward account based upon the determined number of rewards points.

2. A method in accordance with claim 1, wherein the indication of a game-based achievement includes a unique identifier for the game-based achievement, and wherein the method further comprises:
generating a database query including the unique identifier;
transmitting the database query to a database;
receiving, from the database, results of the query; and
receiving from the database a number of rewards points based on the results of the query.

3. A method in accordance with claim 1, wherein the indication of a game-based achievement includes a unique identifier for the game-based achievement, and wherein the method further comprises:
storing, in a database, a plurality of unique identifiers in the cardholder reward account, wherein the plurality of unique identifiers represents the achievements already earned by the cardholder;
generating a database query including the received unique identifier to compare to the plurality of unique identifiers;
transmitting the database query to the database;
receiving, from the database, results of the query; and
determining that the received unique identifier is associated with a newly earned achievement if the received unique identifier is not contained in the plurality of unique identifiers based on the received query results.

4. A method in accordance with claim 1, wherein the at least one computer-based game is a video game that involves human interaction with a user interface to generate visual feedback on a video device for entertainment purposes and wherein the cardholder earns the game-based achievement directly based on the cardholder's actions in the video game.

5. A method in accordance with claim 1, further comprising determining a level for the reward account based, at least in part on, the total number of rewards points.

6. A method in accordance with claim 5, further comprising allowing the cardholder access to one or more additional services based upon the level.

7. A method in accordance with claim 1, further comprising associating a wallet application with the game network, wherein the wallet application is configured to display one or more game-based achievements and the rewards points associated with each of the one or more game-based achievements.

8. A method in accordance with claim 1, wherein the cardholder is able to exchange a plurality of rewards points from the reward account for goods and services.

9. A method in accordance with claim 1, further comprising:
receiving an indication of a payment transaction conducted by the cardholder using the payment card associated with the reward account; and
incrementing the total number of rewards points based upon the payment transaction.

10. A method in accordance with claim 1, wherein the player reward account is associated with a game account based upon the game network.

11. A method in accordance with claim 1, wherein the game network is configured to:
track cardholder actions in one or more computer-based games;
award the game-based achievement based upon the tracked cardholder actions; and
transmit the indication of the game-based achievement to the game rewards computer device.

12. A method in accordance with claim 1, wherein the computer-based game is associated with the game network, and wherein the computer-based game requires interactions by the cardholder as a part of playing the game.

13. A method in accordance with claim 1, wherein the game-based achievement is based upon at least one of achieving a predetermined level in a computer-based game, earning a predetermined number of points in a computer-based game, performing a predetermined series of actions in a computer-based game, completing a computer-based game at a predetermined difficulty level, earning a predetermined number of game-based achievements, earning a predetermining level associated with a game account on the game network, and earning a predetermining number of points associated with a game account on the game network.

14. A game rewards computer device used for enhancing computer game rewards, said game rewards computer device comprising a processor communicatively coupled to a memory device, said processor programmed to:
store a reward account associated with a payment card that is associated with a cardholder, wherein the reward account includes a total number of rewards points;
receive, from a game network, an indication of a game-based achievement associated with the cardholder, wherein the game-based achievement is based upon one or more actions performed by the cardholder in at least one computer-based game;
determine a number of rewards points associated with the game-based achievement; and
increment the total number of rewards points in the reward account based upon the determined number of rewards points.

15. A game rewards computer device in accordance with claim 14, wherein the indication of a game-based achievement includes a unique identifier for the game-based achievement, and wherein said processor is further programmed to:
generate a database query including the unique identifier;
transmit the database query to a database;
receive, from the database, results of the query; and
determine a number of rewards points based on the results of the query.

16. A game rewards computer device in accordance with claim 14, wherein the indication of a game-based achievement includes a unique identifier for the game-based achievement, and wherein said processor is further programmed to:
store, in a database, a plurality of unique identifiers in the cardholder reward account, wherein the plurality of unique identifiers represents the achievements already earned by the cardholder;
generate a database query including the received unique identifier to compare to the plurality of unique identifiers;
transmit the database query to the database;
receive, from the database, results of the query; and
determine that the received unique identifier is associated with a newly earned achievement if the received unique identifier is not contained in the plurality of unique identifiers based on the received query results.

17. A game rewards computer device in accordance with claim 14, wherein said processor is further programmed to determine a level for the reward account based, at least in part on, the total number of rewards points.

18. A game rewards computer device in accordance with claim 17, wherein said processor is further programmed to allow the cardholder access to one or more additional services based upon the level.

19. A game rewards computer device in accordance with claim 14, wherein said processor is further programmed to associate a wallet application with the game network, wherein the wallet application is configured to display one or more game-based achievements and the rewards points associated with each of the one or more game-based achievements.

20. A game rewards computer device in accordance with claim 14, wherein the cardholder is able to exchange a plurality of rewards points from the reward account for goods and services.

21. A game rewards computer device in accordance with claim 14, wherein said processor is further programmed to:
receive an indication of a payment transaction conducted by the cardholder using the payment card associated with the reward account; and
increment the total number of rewards points based upon the payment transaction.

22. A game rewards computer device in accordance with claim 14, wherein said processor is further programmed to:
track cardholder actions in one or more computer-based games;
award the game-based achievement based upon the tracked cardholder actions; and
transmit the indication of the game-based achievement to the game rewards computer device.

23. A game rewards computer device in accordance with claim 14, wherein the computer-based game is associated with the game network, and wherein the computer-based game requires interactions by the cardholder as a part of playing the game.

24. A game rewards computer device in accordance with claim 14, wherein the game-based achievement is based upon at least one of achieving a predetermined level in a computer-based game, earning a predetermined number of points in a computer-based game, performing a predetermined series of actions in a computer-based game, completing a computer-based game at a predetermined difficulty level, earning a predetermined number of game-based achievements, earning a predetermining level associated with a game account on the game network, and earning a predetermining number of points associated with a game account on the game network.

25. At least one non-transitory computer-readable storage media having computer-executable instructions embodied thereon, wherein when executed by a game rewards computer device having at least one processor coupled to at least one memory device, the computer-executable instructions cause the processor to:
store a reward account associated with a payment card that is associated with a cardholder, wherein the reward account includes a total number of rewards points;
receive, from a game network, an indication of a game-based achievement associated with the cardholder, wherein the game-based achievement is based upon one or more actions performed by the cardholder in at least one computer-based game;
determine a number of rewards points associated with the game-based achievement; and
increment the total number of rewards points in the reward account based upon the determined number of rewards points.
